(19) United States
(12) Patent Application Publication
(10) Pub. No.: US 2012/0100446 A1
(43) Pub. Date: Apr. 26, 2012

(54) Hydrogen Storage Using Hydrocarbon Nanostructures and Sonication

(75) Inventor: Boon Keng Teo, Chicago, IL (US)

(73) Assignee: THE BOARD OF TRUSTEES OF THE UNIVERSITY OF ILLINOIS, URBANA, IL (US)

(21) Appl. No.: 13/147,393

(22) PCT Filed: Feb. 8, 2010
(86) PCT No.: PCT/US10/23466

§ 371 Date: Jan. 11, 2012

Related U.S. Application Data
(60) Provisional application No. 61/151,141, filed on Feb. 9, 2009.

(51) Int. Cl. H01M 8/06; B01J 19/10; B82Y 40/00; B82Y 99/00

(52) U.S. Cl. 429/416; 422/127; 204/157.42; 977/900; 977/902

(57) ABSTRACT

Hydrogen storage materials and methods of reversibly storing and generating hydrogen using sonication and hydrocarbon nanostructures are described.

### CROSS REFERENCE TO RELATED APPLICATIONS

This application claims the benefit of U.S. Provisional Application No. 61/151,141, filed Feb. 9, 2009, the disclosure of which is incorporated by reference in its entirety.

### FIELD OF THE INVENTION

The present invention relates to hydrogen storage and release by sonication of hydrocarbon nanostructures.

### BACKGROUND

Low-dimensional nanomaterials are of particular interest in that they exhibit anisotropic and/or dimension-tunable properties (quantum-size effects), both of which are important attributes in nanodevice applications. Recently, two classes of one-dimensional (1-D) nanomaterials, carbon nanotubes (CNTs) and silicon nanowires (SiNWs), have attracted much attention because of their unique properties. Carbon nanotubes are important low-dimensional nanomaterials due to their highly interesting properties, such as high aspect ratio, high mechanical strength, high thermal and chemical stabilities, excellent electrical and thermal transport properties, interesting electronic properties, and the like. [2-15] In fact, single-walled carbon nanotubes can be either metallic or semiconducting with the semiconducting band gap depending upon the chirality, tube diameter and geometry. Since its discovery in 1991, CNT has found its way into many industries.

Silicon nanowires (SiNWs) [16-19] are also important in nanotechnology because Si-based nanoelectronics is totally compatible with the Si-based microelectronics. SiNWs in the nanosize regime exhibit quantum confinement effects and are expected to play a key role as interconnection and functional components in future nanosized electronic and optical devices. Interesting properties such as electrical and thermal conductivities, photoluminescence, and field emission of SiNWs have been reported. Prototype nanodevices such as transistors, diodes, switches, light-emitting diodes, lasers, chemical and biological sensors, and the like, have also been fabricated using SiNWs as key elements. For example, p- or n-type SiNWs can be synthesized during growth by introducing dopants such as boron and phosphorus into SiNWs, and field effect transistors can subsequently be fabricated using p- or n-type SiNWs as channels. [20] Wiring these prototypes together to form logic gates, memories, and circuitries will build the foundation for future nanoelectronic and other devices. Because SiNWs can also be made to emit light or to lase, [21] it is conceivable that nanophotonics [22] will soon be integrated with nanoelectronics in silicon-based nanotechnology.

While many prototype nanodevices based on silicon nanowires have been fabricated, the surface chemistry of SiNWs in general, and the issues of dispersity and stability of SiNWs in particular, remain relatively unexplored. Recent work on SiNWs attempted to address some of these problems. [23-28, 56-70] In particular, etching behavior of SiNWs is different from that of the two dimensional silicon wafer. [56-58] Furthermore, HF-etched silicon nanowires can be used as platforms, templates, or molds to fabricate a wide variety of nanomaterials or nanocomposites. [24,25,64,65] One notable example is the synthesis of hydrocarbon nanotubes (HCNTs) and carbon nanotubes (CNTs) using SiNWs as nanomolds (via sonochemical reactions on the SiNW surfaces) at room temperature and atmospheric pressure. See U.S. Pat. No. 7,132,126, the disclosure of which is incorporated by reference in its entirety; and [59-61]. With role reversal utilizing other materials, such as CNTs or zeolites as templates, a wide variety of silicon-based nanomaterials also can be made. [62,63,66]

### SUMMARY

Disclosed herein are methods of storing and releasing hydrogen and devices for the same.

In one aspect, disclosed herein is a method of generating hydrogen comprising sonicating a hydrocarbon nanostructure suspended in a non-reactive solvent at a frequency of at least 20 kHz to form a carbon nanostructure and generate hydrogen. In some embodiments, the hydrocarbon nanostructure comprises hydrocarbon nanotubes and/or hydrocarbon nano-onions. In various cases, the non-reactive solvent comprises an oil. In some specific embodiments, the non-reactive solvent is selected from the group consisting of castor oil, mineral oil, silicone oil, polyalphaolefin, low melt wax, ethylene glycol, water, and mixtures thereof. In various cases, the hydrocarbon nanostructure is essentially free of silicon nanowires and/or silicon nanodots. In some cases, the hydrogen generation occurs at ambient temperature, ambient pressure, or both.

In another embodiment, the method further comprises absorbing hydrogen on the carbon nanostructure to regenerate the hydrocarbon nanostructure. In some cases, the absorbing comprises sonicating the carbon nanostructure in an organic solvent in the presence of a silicon nanowire, a silicon nanodot, or both a silicon nanowire and a silicon nanodot to form the hydrocarbon nanostructure. In various cases, the organic solvent is an alkyl halide, aromatic hydrocarbon, or mixture thereof. In some specific embodiments, the organic solvent is selected from the group consisting of chloroform, methylene chloride, methyl iodide, benzene, toluene, xylenes, and mixtures thereof.

In another aspect, provided herein is a hydrogen storage device comprising a sonicator and a container comprising a plurality of hydrocarbon nanostructures. In some embodiments, the hydrocarbon nanostructures comprise hydrocarbon nanotubes, hydrocarbon nano-onions, or both. In various cases, the hydrocarbon nanostructures are suspended in a non-reactive solvent. In specific cases, the non-reactive solvent comprises an oil. In some embodiments, the non-reactive solvent is selected from the group consisting of castor oil, mineral oil, silicone oil, polyalphaolefin, low melt wax, ethylene glycol, water, and mixtures thereof. In various embodiments, the hydrogen storage device is essentially free of silicon nanowires, silicon nanodots, or both. In some embodiments, the hydrogen storage device is rechargeable (e.g, to provide hydrogen nanostructures from carbon nanostructures).

The container can be replaceable. In some cases, the container comprises a material capable of allowing sonic waves to pass through. In some cases, the sonicator is inside the container, while in other cases, the sonicator is outside the container. In specific cases, the sonicator is immersed in the non-reactive solvent.

Yet another aspect provides a fuel cell vehicle comprising a vehicle and a hydrogen storage device as disclosed herein.

### BRIEF DESCRIPTION OF FIGURES

FIG. 1A shows a high resolution tunneling electron microscopy (HRTEM) image of a typical multi-walled CNT with interlayer spacing of 3.4 Å and 8 walls. The inner and outer diameters of this CNT measure 4 and 10 nm, respectively. FIG. 1B shows a HRTEM image of a typical multi-walled HCNT with wavy layers and variable interlayer spacing of 4 to 6 Å. The inner and outer diameters of this HCNT measure 3 and 18 nm, respectively.

FIG. 2a shows a TEM image of the extrusion of a multi-layer HCNT from a H-passivated SiNW. FIG. 2b shows the silicon mapping and FIG. 2c shows the carbon mapping.

FIG. 3 shows HRTEM images of HF-etched SiNWs in CHCl₃ as a function of sonication time, namely: (a) 0 (mechanical stiffing only), (b) 5, (c) 10, (d) 15, and (e) 20 minutes.

FIG. 4 shows HRTEM images of HF-etched SiNWs in benzene as a function of sonication time, namely: (a) 10, (b) 20, and (c) 30 minutes.

FIG. 5 shows Raman scattering spectra, in the 1150-1800 cm⁻¹ region, of HCNT on SiNWs synthesized from a CHCl₃ solution.

FIG. 6 shows FTIR of as-prepared HCNT/CNT on SiNWs, where the SiNWs were etched with 5% HF for 5 minutes and sonicated in CHCl₃ for 30 minutes.

FIG. 7 shows an HRTEM image of a hybrid HCNO/CNOs (with CHCl₃ as solvent) showing the ultrasonic explosion. Note that three or four outer layers of the nano-onion are wavy, indicative of the hydrocarbon nano-onion (HCNO) structure, whereas the inner layers are smooth, suggesting a carbon nano-onion (CNO) interior.

FIG. 8 shows HRTEM images of a “self-healing” process of HCNT (from CH₂Cl₂) under intense electron beam irradiation during the TEM observation: (a) an original HCNT before electron beam irradiation; (b) one example of the self-sealed fused “caps” at the cleaved ends of the HCNT after cutting by electron beam irradiation, (c) a separate, badly damaged, sealed-off HCNT tube hanging off a SiNW after cleaving by prolonged electron beam irradiation.

### DETAILED DESCRIPTION

Disclosed herein are methods of absorbing and desorbing hydrogen on or from hydrocarbon nanostructures, such as hydrocarbon nanotubes and nanodots. More specifically, disclosed herein is the use of hydrocarbon nanostructures formed from SiNWs and organic solvents via sonication as hydrogen storage materials. It has been discovered that SiNWs, after etching, and in the presence of an organic solvent under ultrasonication, form hydrocarbon nano structures.

Large quantities of hydrocarbon nanostructures, including hydrocarbon nanotubes (HCNT) and hydrocarbon nano onions (HCNO) (collectively referred to as HCNT(O)s), can be prepared in an organic solution under ambient conditions (such as at room temperature and atmospheric pressure). Ambient conditions include temperatures of about −20° C. (e.g., outdoor temperatures during winter) to about 40° C. (e.g., outdoor temperatures during summer) and pressures of about 0.5 atm to about 1.2 atm (e.g., the pressure variation from sea level to mountainous regions). In general, ambient temperature and pressure refer to the temperature and pressure of the surroundings, without alteration by mechanical devices.

SiNWs and SiNDs (silicon nanodots) are used as a starting material. Hereafter SiNWs and SiNDs are referred to collectively as SiNW(D)s. HCNT(O)s, preferably having lattice interlayer spacing ranging from 3.4 Å to 5 Å, can be produced in large quantities using SiNW(D)s as templates and catalysts. Since the simple, common, and inexpensive organic solvents can be used, these environmentally and economically benign HCNT(O)s are useful in many applications.

The hydrocarbon nanostructures can be used in a hydrogen storage device and in a fuel cell vehicle. The hydrogen storage device can comprise a sonicator and a container comprising hydrocarbon nanostructures sonicated from HF-etched SiNW(D)s, either suspended or dispersed in a non-reactive solvent or in a solid form, where sonication of the hydrocarbon nanostructures releases hydrogen gas. In some embodiments, the hydrocarbon nanostructures are essentially free of SiNWs and/or S NDs. As used herein, “essentially free” indicates less than 5 wt % SiNW(D)s present, or less than 4 wt %, less than 3 wt %, less than 2 wt %, less than 1 wt %, or less than 0.5 wt %.

The container can be fabricated from sonicatable material (e.g., a material capable of allowing sonic waves through the material to reach the contents of the container). In some specific embodiments, the hydrocarbon nanostructures in the container are exposed to sonic waves produced by a sonciator outside the container. In still other embodiments, the sonicator is within the container. In a specific embodiment, the sonicator is immersed in the non-reactive solvent in which the hydrocarbon nanostructures are suspended or dispersed. The immerse-type sonicator may comprise a series of converters and horns where the electrical energy is transformed to mechanical energy using piezoelectric crystals and the vibration is amplified and transmitted down the horns where the tips longitudinally expand and contract to produce the sonic waves.

The hydrogen storage device can be mounted into a vehicle, and the hydrogen gas resulting from the sonication of the hydrocarbon nanostructures can be the fuel for the vehicle. In some cases, the container of the hydrogen storage device is rechargeable by the consumer. In additional or alternative embodiments, the container of the hydrogen storage device is recyclable and/or replacable (e.g., removable from the vehicle) and recharged at a station or factory.

### Silicon Nanowires and Formation of HCNT(O)S

Silicon nanowires are one-dimensional wires of silicon, which can be synthesized by various chemical vapor deposition or physical vapor deposition methods, including thermal evaporation or laser ablation of SiO or Si+SiO₂ or laser ablation or chemical vapor depositions using metal-containing silicon targets. The silicon oxide layer of the as-prepared SiNWs serves as a protective layer, rendering the as-prepared SiNWs relatively inert. The inertness of the as-prepared SiNWs is unfavorable for most applications of SiNWs in nanotechnology. Further fabrication and/or processing require removal of the oxide layer. The most widely used technique for removing the oxide layer from the silicon surface is by etching with dilute hydrofluoric acid (2 to 5% HF). It is known from studies of 2-D Si wafers that, after HF treatment, the silicon surfaces are hydrogen-passivated. The surfaces of the HF-etched samples were terminated with hydrogen (i.e. SiHₓ, where x can be 1, 2, or 3), which made the wires a mild reducing agent. For example, the HF-treated samples can reduce various metal ions, such as silver, copper, gold, and the like, to metal nanostructures at room temperature (Sun et al., J. Appl. Phys., 89, P6393, 2001). When HF-etched silicon nanowires were dispersed in any of the common carbon-containing organic solvents; such as chloroform (CHCl₃), methylene chloride (CH₂Cl₂), methyl iodide (CH₃I), benzene (C₆H₆), and the like by bath sonication at room temperature and atmospheric pressure, the solution changed to a colloidal appearance (Tyndal effect) in minutes.

SiNWs prepared by the thermal evaporation technique are known to have a crystalline silicon core of approximately 15-20 nm in diameter and are sheathed with a thin amorphous oxide layer.

The HF-etched SiNW(D)s are dispersed in solvents which are hydrophobic and immiscible with water (referred to as Class A solvents), e.g., having a partition constant (LogP) greater than 0. Non-limiting examples of Class A solvents include halogenated hydrocarbons, aliphatic hydrocarbons, alkenes and alkynes, and halogenated alkenes and alkynes, saturated and unsaturated cyclic hydrocarbons, oxygen-containing solvents, nitrogen-containing solvents, and the like. Class B solvents are hydrophilic and miscible with water, e.g., having a LogP less than 0.

After HF-treatment, the SiNW surfaces are terminated by hydrogen atoms, forming surface SiHₓ (x=1, 2, 3) species. Because SiHₓ moieties are hydrophobic, the HF-etched SiNWs can be solvated and dispersed well in hydrophobic solvents. The degree of dispersion of the SiNWs can be adjusted by adjusting parameters, such as the concentration of the SiNW solution, the solvent type, sonication time, and/or sonication power. Through adjustment of these parameters, yields and properties (such as viscosity) of the resulting solution, which contains HCNT(O)s and SiNW(D)s, can be varied and effectively controlled.

When HF-etched SiNWs arc dispersed in Class A solvents via sonication under ambient conditions, hydrocarbon nanostructures (e.g., HCNT and HCNO) form, along with carbon nanostructures (e.g., carbon nanotubes (CNT) and carbon nano-onions (CNOs)). These nanostructures are products of sonochemical reactions between HF-etched SiNWs (or SiNDs), respectively, and the organic solvent molecules. These reactions occur at room temperature and atmospheric pressure. Conventional CNTs and CNOs are often produced by such diverse techniques as arc discharge, [1] laser ablation, [11] chemical vapor deposition (CVD), [80] electron beam irradiation and high temperature annealing, [81,82] which usually require severe conditions, such as high temperature, high vacuum, high voltage arc discharge, and/or high-energy electron irradiation. Many of these preparative methods also require sophisticated equipment such as lasers and CVD. The preparation of HCNTs and HCNOs described herein and in U.S. Pat. No. 7,132,126 provides an economical preparation of large quantities of these carbon-based nanomaterials.

The sonochemical reaction can be monitored by ATR-FTIR, UV-Vis, Raman, X-ray absorption spectroscopy (XAS), solid-state NMR (especially CPMAS-NMR of ¹H, ¹³C, and ²⁹Si), and the like. The morphologies and properties of the hydrocarbon and carbon nanomaterials produced can be analyzed by high-resolution transmission electron microscopy (HRTEM), electron energy loss spectroscopy (EELS), ATR-FTIR, Raman, and the like.

Specific solvents that can be used in the disclosed methods to generate HCNT(O)s include, but are not limited to, (1) halogenated hydrocarbons, such as CH₂Cl₂, CHCl₃, CCl₄, CHBr₂CHBr₂, CH₃I, and the like; (2) aliphatic hydrocarbons such as pentane, hexane, butane, octane, and the like; (3) alkenes and alkynes, and halogenated alkenes and alkynes; (4) aromatic hydrocarbons, such as benzene, toluene, xylenes, and the like; (5) saturated cyclohydrocarbons, such as cyclohexane, decalin, and the like; (6) oxygen-containing solvents such as alcohols, polyols, ethylene glycol, ketones (e.g., acetone), ethers, tetrahydrofuran, 1,4-dioxane, acetaldehyde, ethyl acetate, and the like; and (7) nitrogen-containing solvents, such as ethylenediamime, acetonitrile, dimethylformamide, pyridine, aniline, and the like.

Some of the Class A solvents, such as the halogenated hydrocarbons like CHCl₃, show high reactivity and produce structurally well-defined hydrocarbon and carbon nanostructures. In contrast, other halogenated solvents, such as CCl₄, exhibit low reactivity with very little carbon nanomaterials formed. This observation is compatible with the proposed formation pathways, described below. The lack of hydrogen atoms in CCl₄ may preclude the formation of the hydrocarbon nanomaterials (HCNTs and HCNOs) because chemisorption of C—H units on the surfaces of SiNWs is an initial step in the formation of these nanomaterials. It should he emphasized that, in addition to hydrocarbon or carbon nanomaterials, hydrogen-terminated SiNWs also can be used as platforms and templates (molds) in the fabrication of a wide variety of nanomaterials (see, e.g., refs 64 and 65). Here the surface SiHₓ moieties serve as mild reducing agents.

### HCNTS and HCNOS

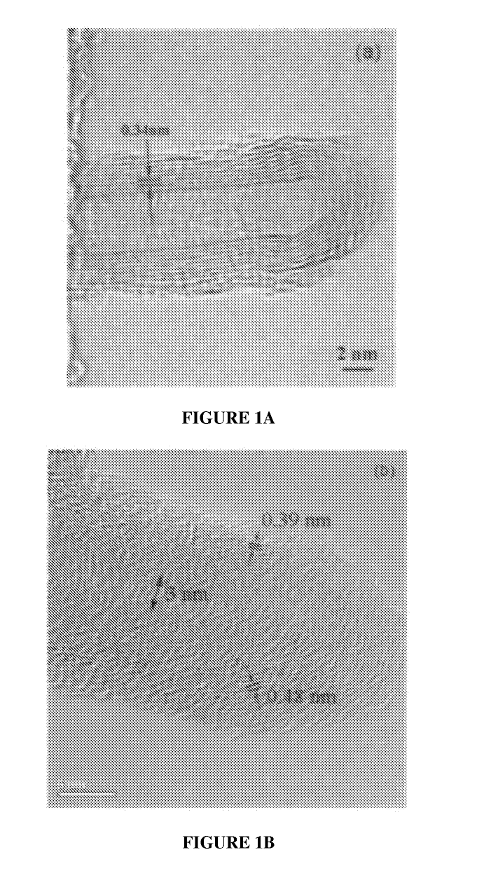

The HCNTs exhibit a wide variety of shapes and forms, the most common ones being the multi-walled hydrocarbon nanotubes (one typical example is shown in FIG. 1B). HCNTs have wavy layers and variable interlayer spacing of 4 to 6 Å. In contrast, conventional CNTs have uniform interlayer spacing of 3.4 Å (FIG. 1A). Both products can be formed using SiNWs as templates. Similarly, HCNOs and CNOs of various sizes and shapes can be formed with SiNDs as templates. Throughout this disclosure, it is understood that all the carbon nanostructures produced by the present method are “multi-walled.”

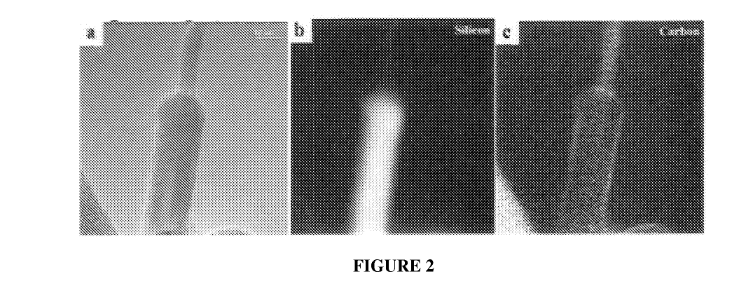

The SiNW(D)s serve as templates and catalysts in the formation of these carbon-based nanostructures. Control experiments in the absence of SiNWs gave rise to little or no carbon nanomaterials. Furthermore, both HCNTs and CNTs have been observed with SiNWs attached (hereafter designated as SiNW(D)⊂HCNT(O) and SiNW(D)⊂CNT(O). respectively, where the symbol ⊂ denotes the “filling” of the carbon nanotubes with silicon nanowires). A typical SiNW⊂HCNT nanowire is shown in FIG. 2a. Element mapping confirmed the chemical compositions of the SiNW template (silicon mapping, FIG. 2b) and the HCNT product (carbon mapping, FIG. 2c). Ultrasonication also is believed to play a key role in the formation of these HCNT(O)s. In fact, sonication not only promotes the heterogeneous reaction between the SiHₓ moieties on the SiNW surfaces and the organic molecules in solution to form the different types of carbon and hydrocarbon nanostructures, but also causes the extrusion (or demolding) of the products (as shown in the TEM images in FIG. 2).

Without being bound by theory, it is hypothesized that the HCNTs and HCNOs are formed by the following mechanism. First, nucleation occurs at the active sites on the surfaces of the silicon nanowires. The active sites contain SiHₓ species which, when exposed to ultrasonication, promote the formation of the basic structural units of carbon source from the organic solvent. Thus, the chemisorbed organic solvent molecules on the surfaces of the SiNWs react with the SiHₓ moieties, and, under the local heating condition of the sonication process, result in the elimination of the substituents of the solvent molecules. It is well known that the acoustic cavitation of ultrasound can induce local heating of up to temperatures as high as 5200 K with lifetimes of <1 μs. [83] In the case of chlorinated solvents, the reaction between the Si—H and C—Cl bonds results in dehydrochorination, giving rise to adsorbed CH units. Subsequent polymerization of these basic units on SiNW surface results in the formation of the hydrogenated graphene sheets [84] (the growth process) which wrap around the SiNW (the templating effect).

While these heterogeneous reactions may be rather complicated, they may be represented as

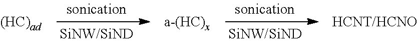

(HC)_{ad} denotes the adsorbed hydrocarbon fragments on the surfaces of the SiNWs after the removal of the solvent substituents (e.g., dehydrochlorination of a chloroform molecule) and a-(HC)ₓ represents the polymerized amorphous hydrocarbons. These hydrocarbon polymer fragments may resemble hydrogenated amorphous carbon (a-C:H) and/or hydrogenated graphite. The joining of these hydrogenated graphite fragments provides rolled-up wavy layers of HCNTs. A similar process for the formation of HCNOs results from silicon nanodots, instead of silicon nanowires.

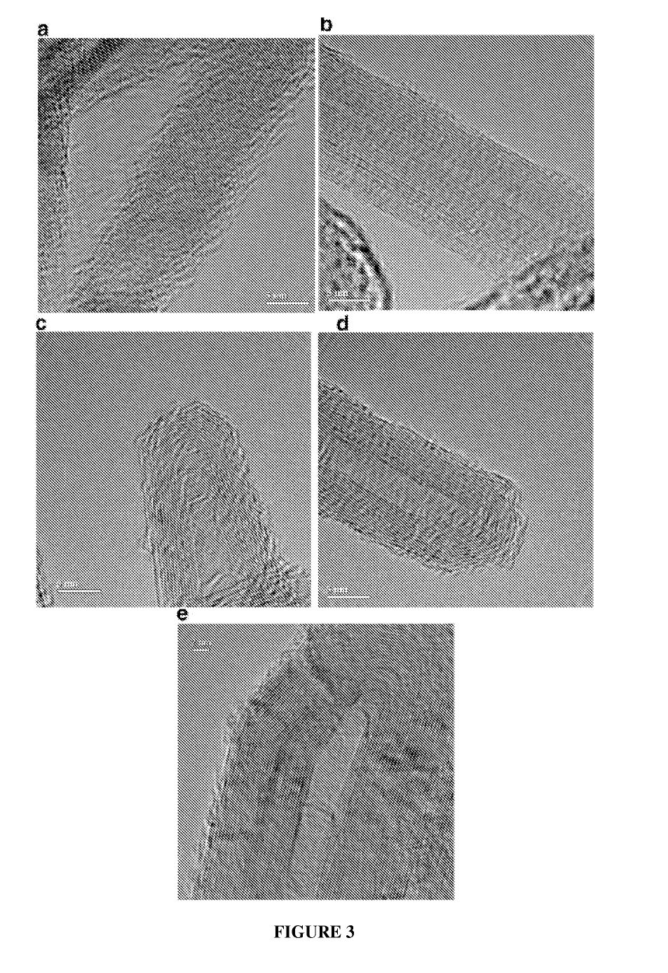

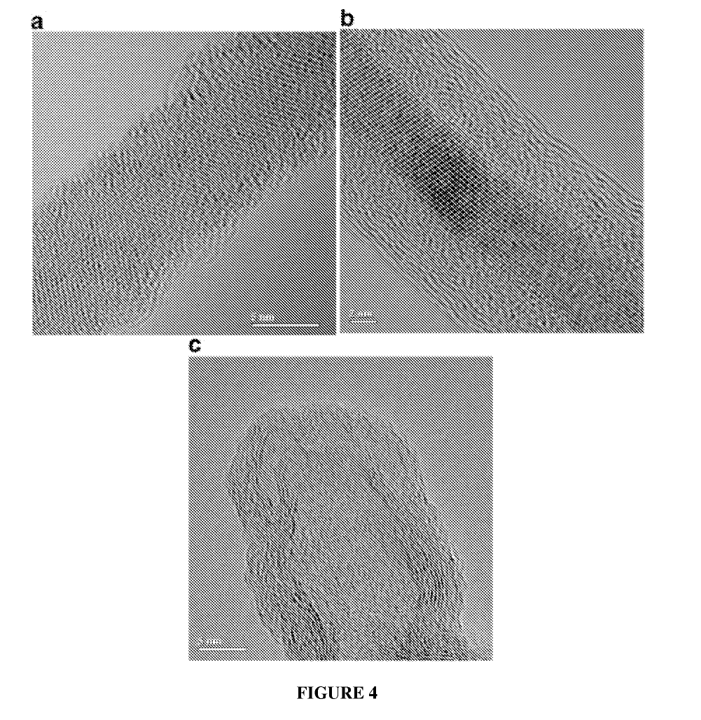

In other words, polymerization of these basic units results in the formation of graphene sheets which wrap around SiNW(D) (the mold). The transformation from chemisorbed amorphous hydrocarbon a-(HC)ₓ to HCNT(O)s can be seen in FIG. 3a to FIG. 3b for CHCl₃. Even more striking is the genesis of the formation of HCNT layers on top of the chemisorbed amorphous hydrocarbon layers in going from FIG. 4a to FIG. 4b for benzene.

The proposed mechanism is consistent with other work. Amorphous carbon nanowires (a-CNW) can be converted to CNTs upon annealing at 900° C. These a-CNWs also contain C—H bonds; and despite its amorphous nature as revealed by HRTEM, these a-CNWs actually contain graphitic building blocks that can polymerize to form highly distorted CNTs upon annealing at high temperatures. The proposed mechanism is also consistent with the observations that (1) CNOs can be formed by heating amorphous carbon film with an electron beam and (2) graphitic carbon film can be formed by heating an amorphous carbon film.

The role of Si—H bonds on the surfaces of SiNW/SiND in the sonochemical synthesis of HCNT(O)s deserves further comment. In fact, fabrication of organic materials on clean or hydrogen-passivated silicon surfaces is not new. In recent years, a variety of the functionalization approaches for formation of structurally and chemically well-defined organic monolayers on clean or hydrogenated silicon (or porous silicon) surfaces in vacuum or in solution have been developed. For example, radical-initiated hydrosilylation, thermal-driven hydrosilylation, photolytic hydrosilylation, etc., of unsaturated carbon compounds have been reported. Most related is the thermal-induced hydrosilylation of alkenes and alkynes.

In the absence of a radical initiator, hydrosilylation through homolytic cleavage of Si—H bonds can occur at a temperature higher than that for radical-initiated hydrosilylation. The high temperature, generally 150-200° C., promotes homolytic cleavage of Si—H to generate silicon radicals or dangling bonds (S—H→Si.+.1) on silicon surfaces. Such a Si radical can react with an unsaturated bond (as in an alkene) to form an alkyl group on the silicon surface via Si—C bond formation and abstraction of a hydrogen atom from an adjacent silicon site. These radical chain reactions can thus propagate on the silicon surface, just as that of radical-initiated reactions. Aliphatic monolayers thus produced on hydrogen-terminated Si surfaces are stable up to 350° C. in a vacuum.

Thermally induced hydrosilylation of alkenes (as well as alkynes) also has been applied to hydrogen-terminated porous silicon surfaces, producing passivating aliphatic monolayers via the same mechanism as in the case of flat (crystalline) silicon surfaces. These latter studies are relevant because porous silicons are known to contain silicon nanowires and nanodots. In view of the extremely high local temperature within the acoustic cavitation of ultrasound, a similar radical mechanism (i.e., homolytic cleavage of Si—H bonds) occurs at the nucleation site(s) on the silicon surfaces of silicon nanowires and nanodots. Such a Si radical can react with a chemisorbed organic molecule, e.g., chloroform, to form the basic carbon units, which then polymerize to form a hydrogenated graphene sheet wrapping around the SiNW(D)s. In the latter process, the interfacial Si—C bonds are eventually severed and replaced by the much stronger C—C bonds of the hydrogenated graphene sheet. Finally, propagation of these free radical chain reactions gives rise to the multilayer HCNT(O)s.

Chemical binding of benzene on Si(100) surface at 300 K, via Si—C a bond formation, has also been thoroughly investigated. Two chemisorption states with desorption peaks at 432-460 and 500 K were found. These studies point to the disruption of the strong pi system of aromatic molecules, such as benzene, and the formation of Si—C sigma bonds upon chemisorption on the silicon surface. Under sonication conditions, the thermally generated Si. radicals on the silicon surface can initiate Si—C bond formation and transfer the unpaired electron to the pi system. The free radical then can propagate through the aromatic pi system, giving rise to C—C sigma formation between benzene molecules, thereby producing the hydrogenated graphene sheet through radical chain reactions, and eventually giving rise to the multilayer HCNT(O)s, in a way similar to that described above for chloroform.

The major differences between the system described herein (referred to as System A) and the aliphatic monolayers produced via hydrosilylation on hydrogen-terminated Si surfaces (referred to as System B) are: (1) the reactants: System A uses small hydrophobic organic molecules (such as chloroform), whereas System B requires unsaturated compounds (such as alkenes); (2) the reaction conditions: System A uses room temperature and atmospheric reaction conditions, whereas System B requires high temperature of 150-200° C.; (3) the products: System A allows fabrication of multilayer HCNT(O)s, whereas System B produces organic monolayers; (4) stability of the products: HCNT(O)s are unstable under sonication conditions; they can transform into conventional CNT(O)s and/or extrude (demold) from the SiNW(D)s upon sonication. They are, however, stable indefinitely under ambient conditions. Aliphatic monolayers produced on hydrogen-terminated Si surfaces through thermal hydrosilylation of alkenes are stable up to 350° C., thereby serving as a passivation layer.

Morphologies of Hybrid Carbon Nanostructures. (1) Hybrid HCNT/CNTs. Hybrid nanostructures are intermediates in the transformation from HCNTs to CNTs, and thus represent snap-shots of the transformation in progress. The smooth CNT layers with an interlayer spacing of 3.4 Å are covered by wavy hydrocarbon layers, with interlayer spacing ranging from 3.5 to 5.9 Å. The observation of these hybrid HCNT/CNTs is significant in that it may shed light on the mechanism of formation of these nanostructures. Similarly, hybrid HCNO/CNOs of various morphologies were observed. (2) Bamboo-like HCNT/CNTs. In addition to hybrid carbon nanotubes and nano-onions, some peculiar morphologies of hybrid carbon nanostructures were also observed. For example, a bamboo-like hybrid HCNT/CNT can be formed, a sealed cone-shaped tube with compartmentalized hollow cavities. (3) Hybrid HCNO/CNOs. Various kinds of hybrid carbon nano-onion or nanoshell structures can also be found, such as truncated rectangle (or a short multiwalled nanotube sealed on both ends), rounded triangular, and rounded diamond shapes.

Characteristics of HCNT(O)s and Hybrid HCNT(O)/CNT(O) Nanostructures.

The characteristics of HCNT and HCNOs (collectively referred to herein as “HCNT(O)s”), which distinguish them from the conventional CNTs and CNOs (collectively referred to herein as “CNT(O)s”), are: (1) wavy layers (for HCNTs) or shells (for HCNOs); (2) large and variable interlayer spacing ranging from about 4 to 6 Å; (3) prolonged sonication can convert HCNT(O) into CNT(O)s; (4) partially hydrogenated; the degree of hydrogenation decreases with the sonication time; and (5) HCNT(O)s are easily shrunk, buckled, damaged, or broken by intense electron beam. These characteristics are also found in the HCNT(O) parts (outer layers) of the hybrid HCNT(O)/CNT(O) nanostructures.

Four Key Components of the Synthesis of HCNT(O)S, CNT(O)S, and the Hybrids:

There are four key components in the sonochemical synthesis of HCNT(O)s, CNT(O)s, and the hybrid intermediates. Lacking any of these components or factors results in no production or very low yield of the products.

(1) The Energy Source: Sonication. Sonication provides the energy needed for the formation of HCNT(O)s. Sonication not only promotes the heterogeneous reaction between the SiHₓ moieties on the SiNW surfaces and the organic molecules in solution, but also causes the extrusion (or demolding) of the products from the SiNWs/SiNDs, respectively. Such transformations and/or processes occur because the acoustic cavitation of ultrasound can induce local heating to temperatures as high as 5200 K with lifetimes of less than 1 μs.

The formation of HCNTs and the subsequent transformation from HCNTs to the hybrid CNT⊂HCNT nanostructures, and ultimately to the conventional CNTs, are shown in FIGS. 3a-e, i.e., the HRTEM images of HF-etched SiNWs in CHCl₃ as a function of sonication time, namely, from 0 to 20 min at 5 min intervals. In particular, FIG. 3a was obtained via mechanical stirring (with the aid of a magnetic stirrer) only. It can be seen that only an amorphous carbon layer was obtained. HCNTs (FIG. 3b) were formed after 5 min sonication. Further sonication progressively transformed HCNTs to the hybrid CNT⊂HCNT nanostructures (FIGS. 3d,e) and eventually to the conventional CNTs (FIG. 3e)).

(2) The Templates: SiNWs and SiNDs. Hydrogen-terminated SiNWs and SiNDs serve as templates in the formation of carbon-based nanostructures. They facilitate the formation of the different types/shapes of carbon and hydrocarbon nanostructures. Indeed, control experiments without SiNWs yielded little or no carbon nanomaterials. Furthermore, both HCNT(O)s and CNT(O)s have been observed with SiNW(D)s attached or detached. The demolded HCNT(O)s, CNT(O)s, or the hybrids often retain the shape of the template (with varying degree of shrinkage in the inner diameter).

(3) Surface Speciation of SiNWs and SiNDs. Etching of as-prepared SiNWs or SiNDs with HF gives rise to hydrogen-terminated SiNW(D) surfaces covered with SiHₓ, (x=1-3) species. To investigate the role of these reactive surface moieties, control experiments were performed with as-prepared SiNW(D)s (covered with oxide). The results showed little or no carbon nanomaterials. Indeed, the reactions may be initiated and/or catalyzed by the surface Si—H moieties on the SiNW(D) surfaces. Under the extreme local temperatures within the acoustic cavity and in halogenated solvents such as CHCl₃ or CH₂Cl₂, the reaction between the Si—H and C—Cl moieties results in dehydrochlorination or dechlorination, giving rise to chemisorbed CH or CH₂ units that subsequently polymerize to form hydrogenated graphite sheets wrapping around SiNWs or SiNDs, thereby forming the HCNTs and HCNOs.

(4) Functionality of the Reactant: The “Solvent” Effect. Most of the common organic solvents can be used as the source of the HCNT(O)s. However, the yield varies with the functionality of the solvent molecule. The efficiency in producing the carbon nanomaterials depends on the dispersion of H-terminated SiNWs in the organic solvent and the reactivity of the solvent molecules on the hydrogen-terminated silicon surface (under sonication conditions). The reactivity depends on the functionality of the solvent. High reactivity can be found in select Class A solvents such as the halogenated hydrocarbons. Among them, chloroform, followed by methylene chloride, exhibits the highest reactivity and produces structurally well-defined hydrocarbon and carbon nanostructures. The relative reactivity of halogen-substituted aliphatic hydrocarbons to give HCNT(O)s decreases with increasing carbon chain length: iodomethane>1,1,2,2-tetrabromoethane>1-bromohexane. Here the long-chain n-hexyl bromide produced very little carbon nanomaterials. Thus, preferred halogen-substituted aliphatic hydrocarbons are those with one carbon unit and several halogen atoms, e.g., the series of CH₃X, CH₂X₂, and CHX₃. Within this group, the relative reactivity seems to follow the general trends of CH₃X<CH₂X₂<CHX₃ and Cl<Br<I. These observations are consistent with the proposed mechanism which requires the departure of the halogen atom(s) as the leaving group (note that I is a better leaving group than Br and Cl) and the formation of basic CH units on the silicon surface as the first step.

Some Class A solvents yield low to poor results, for example, unsubstituted aliphatic hydrocarbons, such as hexane, and certain halogenated solvents, such as CCl₄. CCl₄ exhibits low reactivity with very little carbon nanomaterials formed, even under prolonged sonication. This observation is also in line with the proposed mechanism. Specifically, the lack of hydrogen atoms in CCl₄ may preclude the formation of C—H units on the surfaces of SiNWs, which is an important initial step in the formation of these nanomaterials.

Surprisingly, aromatic hydrocarbons, such as benzene (also a Class A solvent), do not perform as well as chloroform or methylene chloride in producing HCNT(O)s upon sonication in the presence of SiNW(D)s. To probe the formation mechanism of HCNTs in different solvents, and the subsequent transformation from HCNTs to CNTs via the hybrid nanostructures, the HRTEM images of HF-etched SiNWs in benzene were studied as a function of sonication time, namely, from 0 (mechanical stirring only) to 10 to 20 min. The reactions were much slower than in chloroform and the products, including HCNTs or the hybrid CNT⊂HCNT nanostructures, often were irregular in shape. Typical HRTEM images are portrayed in FIG. 4a-c. It can be seen that only an amorphous carbon layer was obtained after 10 min sonication. Further sonication caused the germination of HCNT layers on top of amorphous hydrocarbon layer of wavy HCNT layers, as depicted in FIG. 4b. After prolonged sonication (30 min), irregular-shape hybrid CNT⊂HCNT nanostructures were formed (see FIG. 4c).

Though benzene contains C—H bonds, chemisorption of benzene rings on the surfaces of SiNWs may give rise to stereochemical constraints that hinder the formation of the HCNT layers. Therefore, the reactions are much slower than in chloroform and the products are frequently irregular in shape. Such constraints are absent in the case of free chemisorption C—H units as for CHCl₃.

A number of Class A solvents have also been investigated with different structures and functionalities. One example is cyclic oxygen-containing solvents such as THF and 1,4-dioxane. These solvents produced irregular-shaped HCNT(O)s in low yields.

Characterization and Properties of HCNT(O)S

Prolonged sonication (or higher acoustic power) can cause some of the SiNWs to shed the HCNT(O)s, refreshing the SiNW or SiND surfaces for further reactions. The extruded HCNT(O)s products usually collapse to form solid or hollow tubes or onions (of smaller inner diameters), while retaining the original shapes of silicon nanowires or nanodots (e.g., the molds). One example of the collapsed HCNT as it extrudes from a SiNW is depicted in FIG. 2 (see also FIG. 1b). Upon prolonged ultrasonication, HCNT(O)s (FIG. 1b), with variable interlayer spacing of 4-6 Å, can also be converted to the conventional CNT(O)s (FIG. 1a), with uniform interlayer spacing of 3.4 Å:

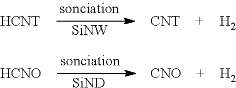

Sonication can be performed at frequencies of at least 10 kHz, at least 15 kHz, or at least 20 kHz. Other frequencies contemplated include about 10 to about 50 kHz, about 20 to about 45 kHz, or about 20 to about 40 kHz. Sonication can be performed at a power of about 1 to 2 kW, or about 10 to about 20 Watt per liter (L). For example, hydrocarbon nanostructures dispersed in 2 L of non-reactive solvent can be sonicated at a power of about 20 W to about 40 W. Sonciation can be performed at a time of about 1 to about 30 minutes, about 5 to about 20 minutes, or about 5 to about 15 minutes. The length of time of the sonication varies with sonication frequency and power, as well as the temperature, pressure, and volume of the system. For example, while higher sonication frequency and power require a shorter time, a larger volume would require a longer time. Lower temperatures (e.g., less than 0° C.) can require longer sonication times, while higher temperatures (e.g., greater than 50° C.) require shorter sonciation times to release hydrogen from the hydrocarbon nanostructures.

It is well known that hydrogen is a cleaner energy than fossil fuel, offering high energy efficiency with no pollution (e.g., as for vehicles run by fuel cells). However, for hydrogen to compete effectively with the existing energy sources, and before a clean “hydrogen economy” can be realized, many technological hurdles such as the generation, storage, transportation, and safety issues must he overcome. [91,92] Among these problems, safe, high-capacity, and low-cost storage of hydrogen is of critical importance.

The methods disclosed herein provide composite nanomaterials as a hydrogen storage system under ambient conditions (room temperature and atmospheric pressure). In addition, both silicon nanowires and carbon nanotubes are “green” and environmentally friendly materials.

The relative proportions of HCNT(O)s, the hybrid intermediates, and the end products CNT(O)s change with sonication time and acoustic power. FIG. 3b-e shows the HRTEM images of selected products from CHCl₃ as a function of the sonication time, ranging from zero (stirring only) to 20 min. The transformation from HCNT(O)s to hybrid intermediates to, ultimately, CNT(O)s is readily apparent. The same is true for benzene, as is demonstrated in going from FIG. 4b to FIG. 4c. It should be noted that sonication causes the transformation from chemisorbed amorphous hydrocarbon (HC)_{ad} units to polymerized amorphous hydrocarbon fragments a-(HC), to HCNT(O)s to hybrid intermediates to CNT(O)s. As the sonication time increases, the relative yields of these products change.

The HCNT(O) to CNT(O) conversion process may begin with the innermost layers (on the SiNW(D) surface) and propagate outward (the “inside-out” mode), or the opposite (the “outside-in” mode). Detailed observation under HRTEM as a function of time revealed that the inner wavy HCNT layers get converted to CNT layers first, and such transformation propagates outward to the outer layers upon prolonged sonication. Subsequent annealing under sonication conditions produces smoother CNT layers. This conversion can happen with or without the SiNW(D)s attached (i.e., before and after demolding).

Further sonication causes SiNW(D)s to shed off HCNT(O)s, refreshing SiNW surfaces for further reactions. Experimentally, it was observed that the demolding process can occur at any stage of the formation or transformation of the carbon nanomaterials.

The new structures of HCNT(O) are formed by networks of chair-form cyclohexane-like hexagonal structure, similar to that of partially hydrogenated graphite on the one extreme and that of amorphous hydrocarbon (a-C:H) on the other. Morphologically, they are similar to the conventional CNTs or CNOs except that C—H bonds have been inserted between layers (walls), thereby converting curved sp2 layers into puckered sp3 layers. Obviously, the more C—H bonds inserted, the larger the interlayer spacing. The interlayer spacing also depends on the degree of packing between adjacent layers. As seen in the HRTEM images, the interlayer spacing can vary from 3.4 to 6 Å.

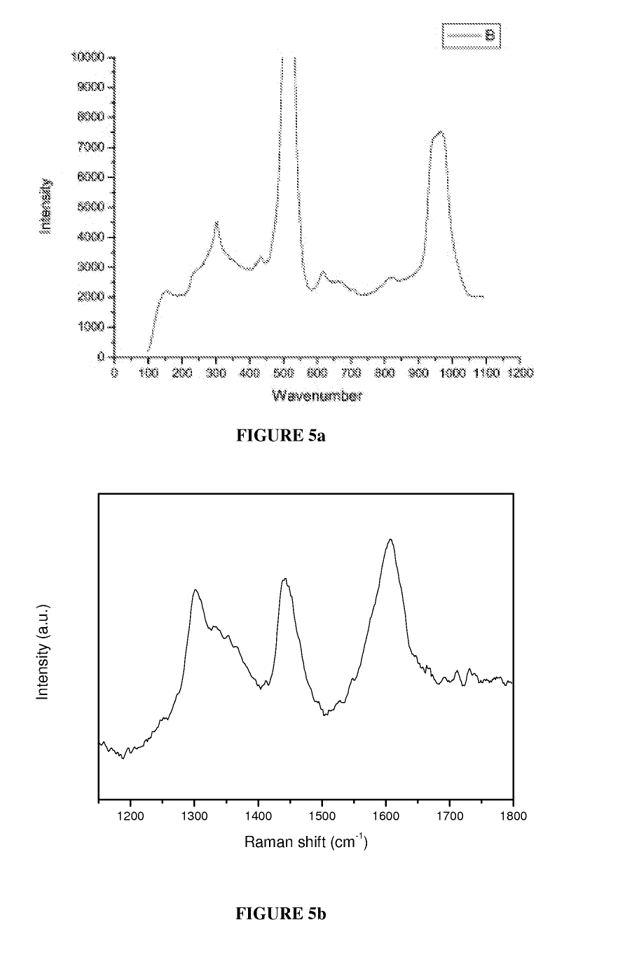

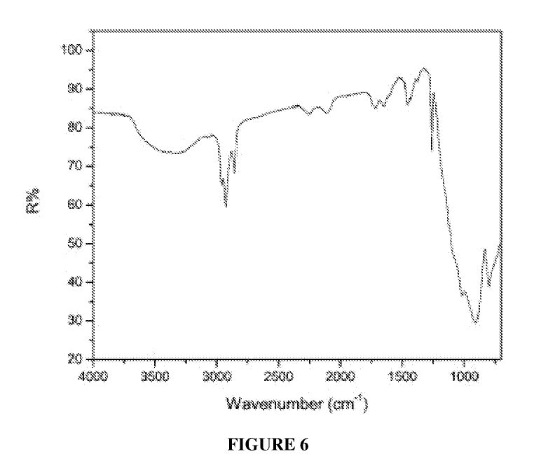

This structure model is supported by spectroscopic evidence. Raman and electron energy loss spectra (EELS) had been previously discussed. The Raman spectrum in the 1100-1800 cm⁻¹ region and a Raman spectrum in the 100-1100 cm⁻¹ region are shown in FIGS. 5a and 5b, and an ATR-FTIR spectrum is shown in FIG. 6.

In the range of 1100-1800 cm⁻¹, there are three weak Raman scattering peaks (excitation: 514 nm) at 1300, 1450, and 1600 cm⁻¹ (c.f., FIG. 5a). The peak at 1300 cm⁻¹ can be assigned to sp3-hybridized single C—C bond, whereas that at 1600 cm⁻¹ is consistent with sp2-hybridized double C═C bond, stretching frequencies of HCNT(O)s. These bands are very different from those of conventional CNTs which generally have a strong so-called graphitic G-band at 1580 cm⁻¹ (sp2 hybridized, C═C stretch) and a much weaker, so-called disorder-induced, D-band at 1348 cm⁻¹ (sp3 hybridized, C—C stretch). The ratio of the intensities of these bands, D/G, for the HCNT(O)s is about one (1), in sharp contrast to that of about 0.15 in most CNTs, consistent with the notion that most of the carbon atoms are hydrogenated (i.e., sp3 hybridized carbons with C—H bonds). Note that the characteristic Raman peak of diamond is at 1332 cm⁻¹, which should serve as the benchmark for sp3 hybridized C—C bonds. The peak at 1450 cm⁻¹ is most interesting. It has not been observed in any CNTs, single- or multi-walled. It has been assigned to a C—C stretch with a formal bond order of 1.5. However, the possibility of this peak being due to a C—H bending mode cannot yet be ruled out. Indeed, the shoulders at 1330, 1350, and 1370 cm⁻¹ (weak peaks) are most likely due to certain vibration modes of C—H bonds.

In the Raman region of 100-1100 cm⁻¹, there are two intense peaks at 517 cm⁻¹ and 960 cm⁻¹ as depicted in FIG. 5b. These peaks can be attributed to the scattering of the first-order optical phonon and the overtone of TO (L) of Si in SiNW(D)s, respectively. The peak at 300 cm⁻¹ is also due to silicon. Like multiwalled CNTs, no discernible peaks were observed for multiwalled HCNTs in the region of 150-380 cm⁻¹ expected for the radial breathing modes (RBM).

The ATR-FTIR spectrum of a typical HCNT/CNT sample is shown in FIG. 6. The C—H stretching frequencies at about 2960, 2925, and 2855 cm⁻¹ are clearly seen. The C—C and C═C bands at 1263 and 1648 cm⁻¹, respectively, as well as the intermediate peak at 1458 cm⁻¹, are in agreement with these observed in the Raman spectrum described above. The differences in wave numbers of IR vs. Raman spectra can be attributed to the different ratios of HCNT vs. CNT in the samples. Also observed in the IR spectrum is the peak at 1725 cm⁻¹ which may be assigned to C═C (or C═C) stretching frequencies. Interestingly, there are two broad (unresolved) Si—H bands in the FTIR at about 2100 and 2250 cm⁻¹, the former being due to unoxidized H-terminated silicon surface, whereas the latter is attributable to oxidized H-terminated silicon surface (i.e., O₃Si—H). The fact that both unoxidized and oxidized H-terminated silicon surfaces are present is also evident in the region around 1000 cm⁻¹. Here three absorption peaks are observed: 910 cm⁻¹ due to unoxidized H-terminated silicon surfaces (Si—H, scissoring modes), and 1050 (in-plane Si—O—Si stretching mode) and 800 (in-plane Si—O—Si bending mode) due to oxidized silicon surfaces.

Upon demolding, the inner and outer diameters of the extruded HCNT(O) or CNT(O) usually shrink by a factor of 2 or more. Some even collapse completely to form a more-or-less solid multiwalled tube or onion. Deformation of the morphologies can also occur in the demolding process, depending upon the types and shapes of the silicon template (mold). Upon demolding, the inner diameters (3-5 nm) of the partially collapsed HCNT(O)s or CNT(O)s are, in general, much smaller than the diameters (10-20 nm) of the SiNW(D) molds because of the shrinkage. And, as expected, for the same SiNW(D) mold, the shrinkage is substantially less for the structurally more rigid CNT(O)s than the HCNT(O)s.

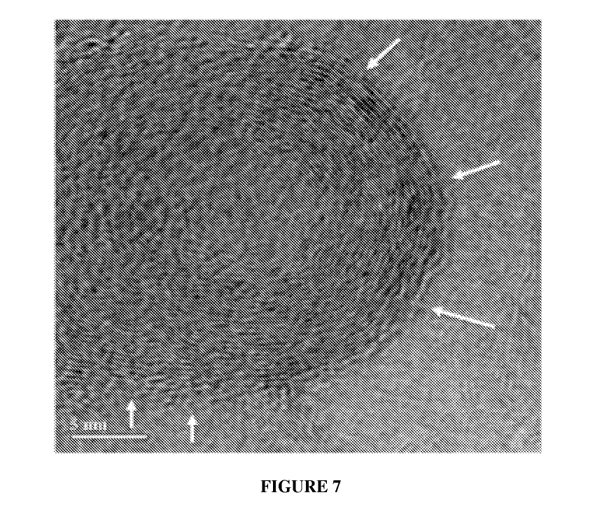

Distinct breaks or pinholes can sometimes be observed on the walls or shells of CNT(O)s or HCNT(O)s. These breaks are believed to be due to “explosive” outgasing caused by either the sonication process or electron irradiation during TEM observation, or both. These “explosions” can be likened to “volcanic eruptions” of gaseous materials from the earth crust. The gaseous materials can be hydrogen molecules released as a result of the dehydrogenation process during the HCNT(O)-to-CNT(O) transformation or foreign materials trapped within the shells or inside HCNT(O) or CNT(O). As indicated by the white arrows in FIG. 7, there are a few tracks radiating from the center of the nano-onion to the outermost shell. Many similar breaks have been observed in other HCNT(O)/CNT(O)s. Some exit points of these tracks on the outermost shell even show severe bulging and/or damage caused by the explosions. These pinholes allow hydrogen molecules to exit (during discharging of hydrogen) or enter (during charging with hydrogen) the interior, or the inner layers (walls of HCNTs or shells, of HCNOs) of the HCNT(O)s.

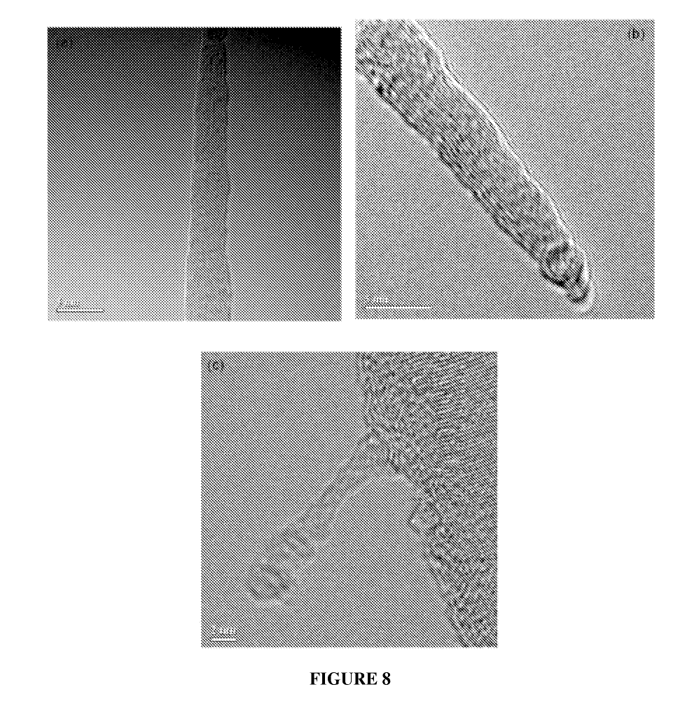

HCNT(O)s are more fragile than CNT(O)s and can easily damage, shrink, or break under intense electron beam during TEM examination. In fact, when a HCNT breaks, the broken ends often “self heal” to form two half “bucky” caps, thereby sealing the broken ends of the separated tubes. This phenomenon is illustrated in FIG. 8. Depending upon the intensity of the electron beam, the “caps” could be in the form of one, two, or more semi-bucky spheres of decreasing diameters fused together at the end of the tubes, resulting in morphologies resembling the shapes of stalactites or icicles. One example is depicted in FIG. 8b, which originated from the tube of FIG. 8a after being broken into two HCNTs by electron beam irradiation. A separate, badly damaged, sealed-off tube protruding from a SiNW is shown in FIG. 8c.

Without the internal support of the encapsulated SiNW(D)s (the molds), the HCNT(O)s, and to a lesser extent, the CNT(O)s, tend to deform to form polyhedral shapes upon demolding. This “polyhedralization” phenomenon is also intimately related to the formation of faceted tubes or polyhedral onions.

Transformations from Round to Faceted Nanostructures. Prolonged ultrasonication can convert demolded HCNT(O)s or CNT(O)s into faceted HCNT(O)s and faceted CNT(O)s ((hereafter designated as f-HCNT(O)s) and f-CNT(O)s), respectively). This process can only happen after demolding. These observations are similar to the well-known conversion of “bucky onion” into faceted or polyhedral bucky onions. Electron beam irradiation of HCNTs (after demolding) can cause buckling or collapse of the tubular structure and, under favorable conditions, result in the formation of HCNOs. Similar transformation from CNTs to CNOs upon intense electron beam irradiation has been reported previously.

Hydrogen Storage and Release

The conversion of HCNT(O)s to form, ultimately, CNT(O)s is an endothermic reaction with energy input from ultrasonication and SiNW(D)s acting as the presumptive catalyst. This conversion process releases hydrogen, and is thus a dehydrogenation reaction, as described above. It follows that the reverse reaction, i.e., the hydrogenation of CNT(O)s to form the HCNT(O)s, must be exothermic and thermodynamically favorable (negative change in Gibbs free energy), provided that the activation energy can be overcome.

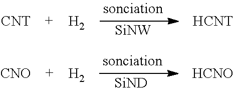

While ultrasonication cannot lower the activation energy, it can provide enough energy to overcome the activation energy barrier. The presumptive dehydrogenation catalyst SiNWs can also catalyze the hydrogenation reaction. Thus, in the presence of a hydrogen source (e.g., hydrogen gas), SiNWs or SiNDs, and under ultrasonication condition, CNT(O)s can be hydrogenated to form the corresponding HCNT(O)s.

These reactions, hydrogenation and dehydrogenation, in effect, constitute hydrogen storage. The release of hydrogen (dehydrogenation) can be affected by ultrasonication. The recharging of hydrogen (hydrogenation) of these carbon nanomaterials can occur at atmospheric pressure under sonication conditions and using SiNWs or SiNDs as catalysts.

The hydrogen storage system described here comprises HCNT(O)s (optionally in the presence of SiNW(D)s), which can optionally be multi-walled, either dispersed in a non-reactive solvent or in a solid form. Release of H₂ is affected by sonication at room temperature, converting HCNT(O)s to CNT(O)s. Recharge of hydrogen can be achieved by hydrogenation under atmospheric (or higher) pressure of H₂ at room temperature, reverting CNTs back to HCNTs. Recharging of hydrogen can be achieved by other means known in the art, such as high temperature and pressure and/or in the presence of a catalyst. The recharging of hydrogen to the CNT(O)s can be performed by (1) raising the temperature of hydrogenation reaction to 300-600° C., (2) increasing the hydrogen pressure to, for example, up to 10 atm, and/or (3) adding a secondary catalysts such as Raney nickel, platinum nanoparticles. Higher hydrogen pressure can also increase physisorption of weakly bound hydrogen molecules in the interior or between the nanotubes or nano-onions, thereby increasing the hydrogen uptake capacity.

Hydrogenation and dehydrogenation reactions can take place with the gel-like composite HCNT(O) material dispersed in non-reactive solvent within a closed container via solid-liquid-gas reactions, or, in the absence of organic solvents, via solid-gas reactions. Contemplated non-reactive solvents include solvents that do not produce HCNT(O)s in the presence of SiNW(D)s under sonication. Specific examples of non-reactive solvents include silicone oil, oil (e.g., castor oil, mineral oil), polyalphaolefin, low melt wax, and the like. Other specific examples of contemplated non-reactive solvents include silicone oil 710 (80° C. to 300° C.), silicone oil 200.50 (30° C. to 278° C.), silicone oil 200.20 (10° C. to 230° C.), silicone oil 200.10 (−30° C. to 160° C.), silicone oil 200.05 (−40° C. to 130° C.), mineral oil (10° C. to 175° C.), and ethylene glycol/water mixture (1:1) (−30° C. to 90° C.), where the temperature range indicated for each solvent indicates a preferred operating temperature for the solvent. These ranges can be extended to close to the freezing and boiling points of the solvents if the viscosity of the system allows efficient mixing under the particular sonication condition.

Other parameters for hydrogen loading and reloading that can be adjusted include SiNW(D) size/diameter, temperature, pressure, and acoustic power requirements. These parameters can affect the long-term reversibility of the reactions, and the integrity of the materials upon long-term cycling. The hydrogen storage capacity of the disclosed materials can be monitored by standard techniques such as temperature-programmed desorption (TPD), thermogravimetric analysis (TGA), volumetric analysis, and the like. The products can be analyzed by high-resolution electron microscopy, single-nanowire/tube EELS, Raman, ATR-FTIR, solid-state NMR, and the like.

The attractive features of the HCNT(O) system disclosed herein as a hydrogen storage medium are: (1) operation at room temperature and atmospheric pressure; (2) the storage material can be produced in situ from low-cost organic solvents such as chloroform; (3) all reactions, ranging from the one-time initial storage material preparation to the hydrogen discharging and recharging operations, can occur within a closed system (container), thereby simplifying the storage, transport, and use of hydrogen as the fuel; (4) all components are reusable, renewable, or recyclable.

The U.S. Department of Energy (DOE) has set a standard of 6.5 wt % for commercially viable reversible hydrogen storage. [91] The use of CNTs as a hydrogen storage medium has been subject of intense research. The absorption mechanism ranges from physisorption to chemisorption, from outside to inside of the nanotubes, to interstitial voids between nanotubes, or combinations thereof.

For the methods disclosed herein, full hydrogenation will mean the formation of a covalent C—H bond for each carbon atom (C:H ratio of 1:1) or a 1/13=7.7% wt % in a fully hydrogenated HCNT(O), thereby meeting the DOE target. This figure could be higher when other weak physisorption, chemisorption, and van der Waals interactions are present. While the DOE has decided to discontinue future applied R&D investment in pure, undoped single-walled carbon nanotubes for vehicular hydrogen storage application based on the gravimetric 6 wt % criterion at or close to room temperature, the disclosed hydrogen storage system is distinctly different. The disclosed hydrogen storage system is based on a hybrid of multi-walled HCNTs and silicon nanowires composite material and the discharging (release) and recharging (storing) of hydrogen are affected by ultrasonication (and thus does not require high temperature or high pressure).

Furthermore, the hydrogen storage system disclosed here meets, or has the potential to meet, most of the key hydrogen storage challenges set forth by DOE for transportation: (a) lightweight; (b) compact (small size); (c) room temperature (no need for cryogenics); (d) atmospheric pressure (no need for high pressure); (e) low energy input (ultrasonication) required (no energy need for compression and liquefaction of hydrogen); (f) excellent durability since all components are robust and stable); (g) the reversibility is expected to allow lifetime of thousands of cycles; (h) refueling time can be accelerated by raising the refueling temperature and pressure; and last, but not least, (i) safe and low cost for the materials and the storage tank (alleviating the need for low temperature and high pressure storage tank for liquid hydrogen, or for specialized tanks for unstable or precious metal materials).

The invention will be more fully understood by reference to the following examples which detail exemplary embodiments of the invention. They should not, however, be construed as limiting the scope of the invention. All citations throughout the disclosure are hereby expressly incorporated by reference.

### EXAMPLES

SiNWs were synthesized by thermal evaporation of SiO powders as described in Lee, et al., MRS Bull., 24:36 (1999). SiNWs were oxide-removed and H-passivated by etching with an aqueous (5%) HF solution for five minutes. Typically, the HCNTs and HCNOs were produced by dispersing about 1 mg of HF-etched SiNW(D)s in 5-10 mL of selected common organic solvents such as CHCl₃, CH₂Cl₂, CH₃I, and the like (categorized as Class A solvents), followed by bath sonication for 15 min in a common laboratory ultrasonic cleaner (40 kHz) under ambient conditions (room temperature and pressure). The golden yellowish solution turned turbid within minutes of sonication and exhibited the Tyndal effect characteristic of colloidal solutions. A few drops of the resulting solution were put onto a lacey carbon film and characterized by high-resolution transmission electron microscopy (HRTEM, Philips 90 CM200 FEG, operated at 200 KeV). All containers or spatulas used were made of Teflon and all solvents used were reagent grade. Triply distilled water was used in preparing the HF solution.

To demonstrate the formation of HCNTs, and the subsequent transformation from HCNTs to the hybrid CNT⊂HCNT nanostructures, and ultimately to the conventional CNTs, the HRTEM images of HF-etched SiNWs in CHCl₃ were studied as a function of sonication time, namely, from 0 to 20 min at 5 min intervals. This was done by removing a few drops of the solution for each specific time interval. The results are depicted in FIGS. 3a-e. FIG. 3a was obtained via mechanical stiffing (with the aid of a magnetic stirrer) only. A similar study was performed on HF-etched SiNWs in benzene as a function of sonication time, namely, from 10 to 20 to 30 min. The results are shown in FIGS. 4a-c, respectively.

The sample for Raman study was prepared as follows. Approximately 1 mg of SiNWs (after treatment with a 5% HF aqueous solution) was dispersed in 2 mL of CHCl₃. The solution was sonicated for 15 min in a common laboratory ultrasonic cleaner (40 kHz) under ambient conditions. A few drops of the resulting solution were dropped onto a glass slide and dried in the air. This procedure was repeated many times until approximately 1 mL of solution was evaporated to produce a thin solid film of 1 cm in diameter. Within the film, small bundles of SiNWs were observed. The sample was subsequently examined by Raman spectroscopy using a Renishaw micro-Raman spectrometer at room temperature. Excitation was by means of the 514 nm line of an Ar⁺ laser, and the Raman signals were measured in a backscattering geometry with a spectral resolution of 1.0 cm⁻¹. The resulting spectrum is shown in FIG. 5.

For FTIR measurements, 1 mg of HF-treated SiNWs was dispersed in 2 mL of CHCl₃. The turbid golden solution was dispersed onto a GaAs wafer and dried in a nitrogen stream. This procedure was repeated several times until approximately 1 mL solution was evaporated to produce a thin solid film of 1 cm in diameter. Within the film, small bundles of SiNWs were observed. The sample was stored under nitrogen until FTIR measurements (in the micro-attenuated total reflection (ATR) mode). The ATR-FTIR measurements was performed in air using a Perkin-Elmer Spectrum One FTIR spectrometer interfaced to an i-Series FTIR microscope equipped with a HgCdTe detector cooled with liquid nitrogen. The micro-ATR objective is a germanium crystal with a probe size of 100 gm in diameter. The resolution of the spectra was 2 cm⁻¹. The resulting spectrum is shown in FIG. 6.

FIG. 7 was obtained with chloroform as solvent and FIGS. 8a-c were obtained from methylene chloride, both via the sample preparation procedure described above for chloroform.

While the present invention has been described in terms of various embodiments and examples, it is understood that variations and improvements will occur to those skilled in the art. Therefore, only such limitations as appear in the claims should be placed on the invention.

### REFERENCES

1 Iijima, Nature, 354:56-58, 1991.
2 Wildoer, et al., Nature, 391:59-62, 1998.
3 Odom, et al., Nature, 391:62-64, 1998.
4 Charlier and Lambin, Physical Review B, 57:R15037-R15039, 1998.
5 Zhou, et al., Chemical Physics Letters, 333:344-349, 2001.
6 Hamada, et al., Phys. Rev. Lett., 68:1579-1581, 1992.
7 Saito, et al., Physical Properties of Carbon Nanotubes, Imperial College Press, London, 1998.
8 Ouyang, et al., Science, 292:702-705, 2001.
9 Collins, et al., Science, 292:706-709, 2001.
10 Ulna, et al., J. Chem. Phys., 104:2089-2092, 1996.
11 Thess, et al., Science, 273:483-487, 1996.
12 Mintmire, et al., Phys. Rev. Lett., 68:631, 1992.
13 Saito, et al., Appl. Phys. Lett., 60:2204, 1992.
14 Saito, et al., Phys. Rev. B., 46:1804, 1992.
15 Saito, et al., Phys. Rev. B., 61:2981, 2000.
16 Morales and Lieber, Science, 279:208-211, 1998.
17 Zhang, et al., Applied Physics Letters, 72:1835-1837, 1998.
18 Holmes, et al., Science, 287:1471-1473, 2000.
19 Yu, et al., J. Phys. Chem. B, 104:11864-11870, 2000.
20 Cui, et al., J. Phys. Chem. B, 104:5213-5216, 2000.
21 Pavesi, et al., Nature, 408:440-444, 2000.
22 Huang, et al., Science, 292:1897-1899, 2001.
23. Teo, et al., Chem. Rev. 107:1454-1532, 2007.
24. Teo, Coord. Chem. Rev., 246: 229-246, 2003.
25. Sun, et al., J. Cluster Sci. 15:199, 2004.
26. Lee, et al., U.S. Pat. No. 7,132,126, Nov. 7, 2006.
Teo, et al., J. Cluster Sci. 17:529-540, 2006.
28. Teo, et al., J. Cluster Sci., 18:346-357, 2007.
56. Sun, et al., Inorg. Chem., 42:2398-2404, 2003.
57. Chen, et al., J. Phys. Chem. B, 109:10871-10879, 2005.
58. Teo, et al., J. Phys. Chem. B, 109:21716-21724, 2005.
59. Sun, et al., J. Am. Chem. Soc., 124:14856-14857, 2002.
60. Li, et al., Chem. Mater., 17:5780, 2005.
61. Lee, et al., U.S. Pat. No. 7,132,126, Nov. 7, 2006.
62. Sun, et al., J. Am. Chem. Soc., 124:14464-14471, 2002.
63. Teo, et al., Inorg. Chem., 42:6723, 2003.
64. Sun, et al., Inorg. Chem., 41:4331-4336, 2002.
65. Li, et al., J. Phys. Chem. B, 106:6980-6984, 2002.
66. Li, et al., Chem. Phys. Lett., 365:22-26, 2002.
67. Teo, et al., Nano Lett., 3:1735-7, 2003.
68. Zhang, et al., Chem. Phys. Lett., 364:251-258, 2002.
69. Zhang, et al., Phys. Chem. B, 109:8605-8612, 2005.
70. Zhang, et al., Phys. Rev. B, 69:125319, 2004.
71 Lee, et al., MRS Bulletin, 24:36-42, 1999.
72 Wang, et al., Chem. Phys. Lett., 299:237-242, 1999.
73 Zhang, et al., J. Crystal Growth, 197:136-140, 1999.
74 Zhang, et al., Adv. Mater., 15:635-640, 2003.
75 Burrows, et al., Appl. Phys. Lett, 53:998-1000, 1988.
76 Higashi, et al., Appl. Phys. Lett., 56:656-658, 1990.
77 Chabal, et al., J. Vac. Sci. Tech. A, 7:2104-2109, 1989.
78 Jakob and Chabal, J. Chem. Phys., 95:2897-2909, 1991.
79 Hines, et al., Phys. Rev. Lett., 71:2280-2283, 1993.
80 Kong, et al., Chem. Phys. Lett., 292:567-574, 1998.
81 Ugarte, Nature, 359:707-709. 1992.
82 Deheer and Ugarte, Chem. Phys. Lett., 207:480-486, 1993.
83 Suslick, et al., Ann. Rev. Mater. Sci., 29:295-326, 1999.
84 Nishihara, et al., Chem. Soc. Farad., 87:1187, 1991.
85 Zou, et al., Nano Lett., 4:1181-1186, 2004.
86 Zou, et al., J. Cluster Sci., 17:565-578, 2006.
87 Wu, et al., Nano Lett., 4:2337-2342, 2004.
88 Wang, et al., Chem. Mater., 16:5169-5181, 2004.
89 Bogart, et al., Adv. Mater., 17:114, 2005.
90 Zhang, et al., Adv. Mater., 13:1238-1241, 2001.
91 U.S. Department of Energy (DOE): Energy Efficiency and Renewable Energy, “Hydrogen, Fuel Cells and Intrastructure Technologies Program-Hydrogen Storage: (a) Gaseous and Liquid Storage; (b) Materials-based Storage; (c) Hydrogen Storage Challenges; and (d) Status of Hydrogen Storage Technologies.”
92 Schlapbach and Zuttel, Nature, 414:353, 2001.
93 Dillon, et al., Nature, 386:377-379, 1997.
94 Liu, et al., Science, 286:1127, 1999.
95 Chen, et al., Science, 285:91, 1999.
96 Pekker, et al., J. Phys. Chem. B., 105:7938-7943, 2001.
97 Ding, et al., J. Nanosci. Nanotech., 1:7-29, 2001.
98 Ding, et al., Encyclo. Nanosci. Nanotech., 4:13-33, 2004.
99 Froudakis, Encyclo. Nanosci. Nanotech., 4:1-11, 2004.
100 Mpourmpakis, et al., Nano Lett., 6:1581-1583, 2006.
101 Zhao, et al., J. Chem. Phys., 122:214707, 2005.

1. A method of generating hydrogen comprising
sonicating a hydrocarbon nanostructure suspended in a non-reactive solvent at a frequency of at least 20 kHz to form a carbon nanostructure and generate hydrogen.

2. The method of claim 1, wherein the frequency of the sonicating is 20 kHz to about 40 kHz.

3. The method of claim 1, wherein the non-reactive solvent comprises an oil.

4. The method of claim 1, wherein the non-reactive solvent is selected from the group consisting of castor oil, mineral oil, silicone oil, polyalphaolefin, low melt wax, ethylene glycol, water, and mixtures thereof.

5. The method of claim 1, wherein the hydrocarbon nanostructure comprises a hydrocarbon nanotube.

6. The method of claim 1, wherein the hydrocarbon nanostructure comprises a hydrocarbon nano-onion.

7. The method of claim 1, wherein the hydrogen is generated at an ambient temperature.

8. The method of claim 1, wherein the hydrogen is generated at an ambient pressure.

9. The method of claim 1, wherein the hydrogen nanostructure is essentially free of silicon nanowires, silicon nanodots, or both silicon nanowires and silicon nanodots.

10. The method of claim 1, further comprising absorbing hydrogen on the carbon nanostructure to regenerate the hydrocarbon nanostructure.

11. The method of claim 10, wherein the absorbing comprises sonicating the carbon nanostructure in an organic solvent in the presence of a silicon nanowire, a silicon nanodot, or both a silicon nanowire and a silicon nanodot to form the hydrocarbon nanostructure.

12. The method of claim 11, wherein the organic solvent is an alkyl halide, aromatic hydrocarbon, or mixture thereof.

13. The method of claim 12, wherein the organic solvent is selected from the group consisting of chloroform, methylene chloride, methyl iodide, benzene, toluene, xylenes, and mixtures thereof.

14. A hydrogen storage device comprising a sonicator and a container comprising a plurality of hydrocarbon nanostructures.

15. The hydrogen storage device of claim 14, wherein the hydrocarbon nanostructures comprise hydrocarbon nanotubes.

16. The hydrogen storage device of claim 14, wherein the hydrocarbon nanostructures comprise hydrocarbon nano-onions.

17. The hydrogen storage device of claim 14, wherein the hydrocarbon nanostructures are suspended in a non-reactive solvent.

18. The hydrogen storage device of claim 17, wherein the non-reactive solvent comprises an oil.

19. The hydrogen storage device of claim 17, wherein the non-reactive solvent is selected from the group consisting of castor oil, mineral oil, silicone oil, polyalphaolefin, low melt wax, ethylene glycol, water, and mixtures thereof.

20. The hydrogen storage device of claim 14 essentially free of silicon nanowires, silicon nanodots, or both.

21. The hydrogen storage device of claim 14, wherein the hydrogen storage device is rechargeable.

22. The hydrogen storage device of claim 14, wherein the container is replaceable.

23. The hydrogen storage device of claim 14, wherein the container comprises a material capable of allowing sonic waves to pass through.

24. The hydrogen storage device of claim 14, wherein the sonicator is inside the container.

25. The hydrogen storage device of claim 24, wherein the sonciator is immersed in the non-reactive solvent.

26. The hydrogen storage device of claim 14, wherein the sonicator is outside the container.

27. A fuel cell vehicle comprising a vehicle and the hydrogen storage device of claim 14.
